(19) United States
(12) Patent Application Publication
(10) Pub. No.: US 2012/0288144 A1
(43) Pub. Date: Nov. 15, 2012

(54) IMAGE PROCESSING APPARATUS, IMAGE PROCESSING METHOD, AND MOTION DETECTION SYSTEM

(75) Inventors: Keiichiro Yanagida, Tokyo (JP); Akira Yoshino, Tokyo (JP); Teppei Nakano, Kanagawa (JP)

(73) Assignee: Kabushiki Kaisha Toshiba, Tokyo (JP)

(21) Appl. No.: 13/414,033

(22) Filed: Mar. 7, 2012

(30) Foreign Application Priority Data
May 13, 2011 (JP) 2011-108240

(51) Int. Cl. G06K 9/00

(52) U.S. Cl. 382/103

(57) ABSTRACT

According to one embodiment, an image processing apparatus includes an integrator and a motion determination unit. The motion determination unit determines movement of an object. The integrator integrates information on a first frame in a unit domain in the image of each frame, and integrates information on a second frame while inverting a sign of a signal level in the integration of the first frame. The motion determination unit makes the motion determination in the unit domain according to the integration result of the integrator.

### CROSS-REFERENCE TO RELATED APPLICATIONS

This application is based upon and claims the benefit of priority from Japanese Patent Application No. 2011-108240, filed on May 13, 2011; the entire contents of all of which are incorporated herein by reference.

### FIELD

Embodiments described herein relates generally to an image processing apparatus, an image processing method, and a motion detection system.

### BACKGROUND

For example, a motion detection system that determines movement of an object from a difference obtained by a comparison of pieces of luminance data of images is well known as a motion detection system that detects the movement of the object from the image. In the case that the pieces of luminance data in at least two frames are compared with respect to a whole screen, because a camera module requires a frame memory for at least two frames, unfortunately a circuit scale is enlarged. When the frame memory is reduced in order to solve the problem of the enlargement of the circuit scale, unfortunately accuracy of the motion determination is degraded.

In the case that control according to an object moving direction or an object moving speed is not required, for example, sometimes a pyroelectric sensor is used instead of the camera module in a monitoring system that monitors existence or non-existence of an invader. Although the circuit scale can be reduced in a system in which the pyroelectric sensor is used, the system is not suitable for a use application in which visual checking of the invader is desired.

### BRIEF DESCRIPTION OF THE DRAWINGS

FIG. 1 is a block diagram illustrating a configuration of a motion detection system to which an image processing apparatus according to a first embodiment is applied;

FIG. 2 is a view illustrating integration of a luminance signal by an integrator;

FIG. 3 is a block diagram illustrating a configuration of an image processing apparatus according to a second embodiment;

FIG. 4 is a view illustrating integration of a luminance signal by each integrator; and

FIG. 5 is a view illustrating an operation of an image processing apparatus according to a third embodiment.

### DETAILED DESCRIPTION

In general, according to one embodiment, an image processing apparatus includes an integrator and a motion determination unit. The integrator integrates information in each pixel obtained from an image signal. The motion determination unit detects a time-series change of a captured image from an integration result of the integrator. The motion determination unit determines movement of an object in the image. The integrator integrates information on a first frame in a unit domain in the image of each frame, and integrates information on a second frame while inverting a sign of a signal level in the integration of the first frame. The unit domain is a unit of a motion determination in the motion determination unit. The second frame is subsequent to the first frame. The motion determination unit makes the motion determination in the unit domain according to the integration result of the first frame and the second frame in the integrator.

Exemplary embodiments of an image processing apparatus, an image processing method, and a motion detection system will be described below in detail with reference to the accompanying drawings. The present invention is not limited to the following embodiments.

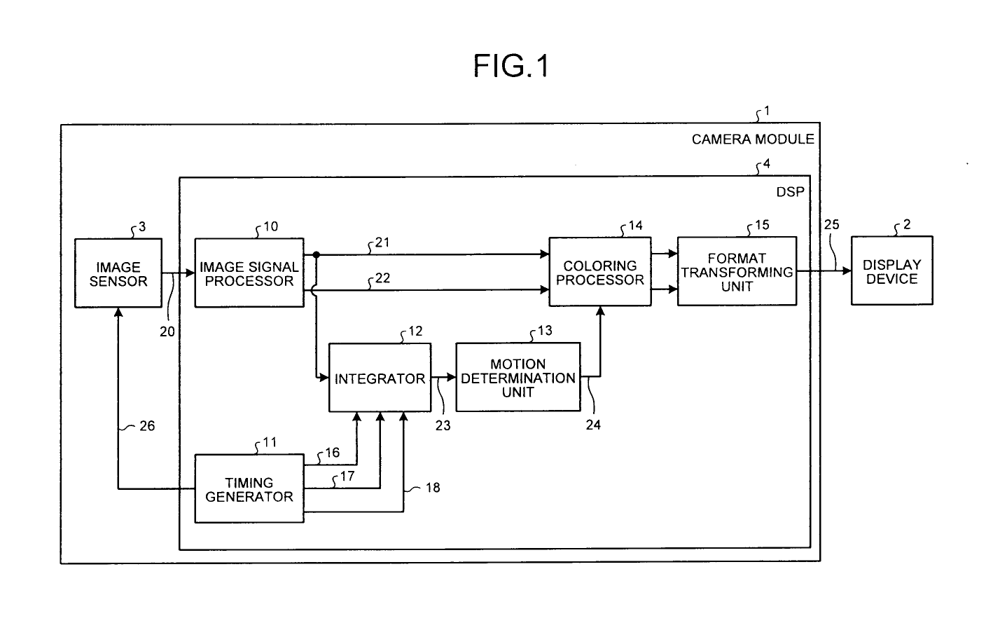

FIG. 1 is a block diagram illustrating a configuration of a motion detection system to which an image processing apparatus according to a first embodiment is applied. The motion detection system includes a camera module 1 and a display device 2. The camera module 1 captures the image. The display device 2 displays the image captured by the camera module 1. For example, the display device 2 is a liquid crystal display.

The camera module 1 includes an image sensor 3 and a digital signal processor (DSP) 4. The image sensor 3 converts light from a subject into a signal charge and outputs an image signal 20. The DSP 4 that is of the image processing apparatus performs image processing to the image signal 20 from the image sensor 3.

The DSP 4 includes an image signal processor 10, a timing generator 11, an integrator 12, a motion determination unit 13, a coloring processor 14, and a format transforming unit 15. The image signal processor 10 performs various pieces of calculation processing to the image signal 20 input to the DSP 4, and generates a luminance signal 21 and a color-difference signal 22.

The integrator 12 integrates the luminance signal 21 and outputs an integration value 23 that is of an integration result. The motion determination unit 13 determines the movement of the object in the image and outputs a determination result signal 24. The motion determination unit 13 detects the time-series change of the image captured by the camera module 1 from the integration value 23.

The coloring processor 14 performs screen coloring display processing to the luminance signal 21 and the color-difference signal 22 in response to the determination result signal 24 indicating that the object moves. The format transforming unit 15 performs a format transform suitable for the display device 2 to the luminance signal 21 and the color-difference signal 22 from the coloring processor 14, and outputs a display image signal 25. The display device 2 displays the image in response to the display image signal 25 output from the DSP 4.

The timing generator 11 outputs an integration timing signal 16, an integration value read timing signal 17, a sign switching timing signal 18, and a sensor timing signal 26.

The integration timing signal 16 is used to issue an instruction to start the integration to the integrator 12. The integration value read timing signal 17 is used to issue an instruction to output the integration value 23 to the integrator 12. The sign switching timing signal 18 is used to issue an instruction to switch the sign of the signal level to the integrator 12.

The integrator 12 integrates the luminance signal 21 in response to the integration timing signal 16. The integrator 12 outputs the integration value 23 that is of the integration result in response to the integration value read timing signal 17. The integrator 12 inverts the sign of the signal level with respect to the luminance signal 21 that is of an integration target in response to the sign switching timing signal 18.

The sensor timing signal 26 is used to issue an instruction to capture a subject image to the image sensor 3. The timing generator 11 outputs the sensor timing signal 26 in each predetermined frame cycle. The image sensor 3 captures the subject image in response to the sensor timing signal 26.

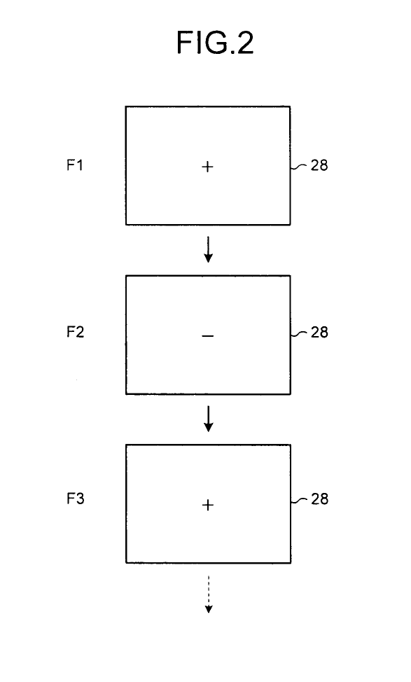

FIG. 2 is a view illustrating the integration of the luminance signal by the integrator. By way of example, the integration of the luminance signal 21 and the motion determination are performed to continuous frames F1, F2, and F3. The integrator 12 integrates the luminance signal 21 in a unit domain 28 in the image of each frame. The unit domain 28 is a unit of the motion determination by the motion determination unit 13. In the first embodiment, the unit domain 28 is set to the whole range of the image.

The timing generator 11 outputs the sensor timing signal 26 for the frame F1 to the image sensor 3. When the generation of the luminance signal 21 is started with respect to the frame F1, the timing generator 11 outputs the integration timing signal 16 to instruct the integrator 12 to start the integration of the luminance signal 21. In response to the integration timing signal 16, the integrator 12 integrates the luminance signal 21 with respect to the unit domain 28 of the frame F1.

The timing generator 11 outputs the sensor timing signal 26 for the frame F2 to the image sensor 3. When the generation of the luminance signal 21 is started with respect to the frame F2, the timing generator 11 outputs the sign switching timing signal 18.

For example, when the luminance signal 21 is positively integrated with respect to the frame F1, the integrator 12 inverts the sign of the signal level of the luminance signal 21 from the positive sign to the negative sign in response to the sign switching timing signal 18. The integrator 12 negatively integrates the luminance signal 21 with respect to the frame F2 after positively integrating the luminance signal 21 with respect to the frame F1.

When the integration of the luminance signal 21 is completed with respect to the frame F2, the timing generator 11 outputs the integration value read timing signal 17. In response to the integration value read timing signal 17, the integrator 12 outputs the integration value 23 with respect to the frame F1 (first frame) and the frame F2 (second frame). When outputting the integration value 23, the integrator 12 resets the previous integration result. The motion determination unit 13 makes the motion determination in the unit domain 28 according to the integration value 23.

When the sign of the signal level is inverted with respect to the frames F1 and F2, the integration values 23 for the frames F1 and F2 become a difference between the luminance signal 21 for the frame F1 and the luminance signal 21 for the frame F2. For example, when no change is generated in the images of the frames F1 and F2, the integration value 23 becomes zero.

The motion determination unit 13 previously retains a determination threshold. The determination threshold is used as a reference to determine whether the change of the image exists. The motion determination unit 13 makes the motion determination by comparing the integration value 23 and the determination threshold.

For example, the determination threshold is set in consideration of an influence of a noise included in the luminance signal 21. The motion determination unit 13 determines that the object does not move in the frames F1 and F2 when the integration values 23 for the frames F1 and F2 are equal to or lower than the determination threshold. The motion determination unit 13 determines that the object moves in the frames F1 and F2 when the integration values 23 for the frames F1 and F2 are more than the determination threshold.

The determination threshold may be either a fixed value or a variable. The motion determination unit 13 may set the determination threshold to zero. In this case, the motion determination unit 13 determines that the object moves when the integration value 23 is a value except zero. The motion determination unit 13 makes the stricter motion determination as the determination threshold is set to a value closer to zero.

The motion determination unit 13 outputs the result of the motion determination as the determination result signal 24. The coloring processor 14 processes the luminance signal 21 and the color-difference signal 22 in response to the determination result signal 24 indicating that the object moves. For example, the coloring processor 14 processes the luminance signal 21 and the color-difference signal 22 such that the whole screen is displayed in a predetermined color.

The motion detection system notifies a user that the movement of the object is detected by the coloring display or; the display device 2. In the coloring processor 14, not only the whole screen may be displayed in a color, but also the screen may partially be displayed in the color.

The coloring processor 14 may perform the coloring display on the display device 2 by any technique such as positive-negative inversion of the luminance signal 21 and the color-difference signal 22, a change of the signal level to a fixed value, and addition of a predetermined color component. The coloring processor 14 may perform processing of the screen coloring display, or perform processing except the processing performed to the luminance signal 21 and the color-difference signal 22.

Not only the coloring processor 14 may perform the coloring display during the movement of the object, but also the coloring processor 14 may continuously perform the coloring display for a given time even after the movement of the object is ended. The coloring processor 14 continuously performs the coloring display for a given time since the determination result signal 24 indicating that the object moves is input.

The motion detection system enables the user to securely recognize that the object moves by continuously performing the coloring display to some extent. The coloring processor 14 may properly change a state of the coloring display as time advances. The coloring processor 14 may alternately perform the coloring display and normal display. For example, the motion detection system may output alarm sound in conjunction with the coloring display.

The timing generator 11 outputs the sensor timing signal 26 to the image sensor 3 with respect to the frame F3. When the generation of the luminance signal 21 is started with respect to the frame F3, the timing generator 11 outputs the sign switching timing signal 18 to the integrator 12.

The integrator 12 inverts the sign of the signal level of the luminance signal 21 from the negative sign to the positive sign in response to the sign switching timing signal 18. The DSP 4 repeats the same operation as the frames F1 and F2 with respect to the frames subsequent to the frame F3. Through the above operation, the motion detection system detects the movement of the object displayed in the image.

In the image processing apparatus of the background art requires two integrators or a data retention unit equivalent to a data amount of two frames when the integration value for the first frame is compared to the integration value for the second frame.

The DSP 4 of the first embodiment detects the time-series change of the image from the integration value 23 integrated through the first and second frames. In the DSP 4, the movement of the object is determined with respect to the two frames using the integrator 12, so that circuit or memory capacity for the integration can be reduced compared with the comparison of the integration values obtained in each frame. Therefore, the motion detection system can detect the movement of the object with the DSP 4 having the simple configuration in which the circuit scale is reduced, and illustrate the detected object as the image.

The DSP 4 is not limited to the case that the motion detection is continuously performed to each frame. The DSP 4 may perform the motion detection at predetermined intervals. The DSP 4 is not limited to the case that the integration of the luminance signal 21 and the motion determination are performed to the continuous first and second frames.

The DSP 4 may perform the integration of the luminance signal 21 and the motion determination between the first and second frames in which a predetermined interval exists therebetween. The DSP 4 can control the outputs of the integration timing signal 16, the integration value read timing signal 17, the sign switching timing signal 18 of the timing generator 11 to properly adjust a frequency of the motion detection, the integration of the luminance signal 21, and timing of the motion determination.

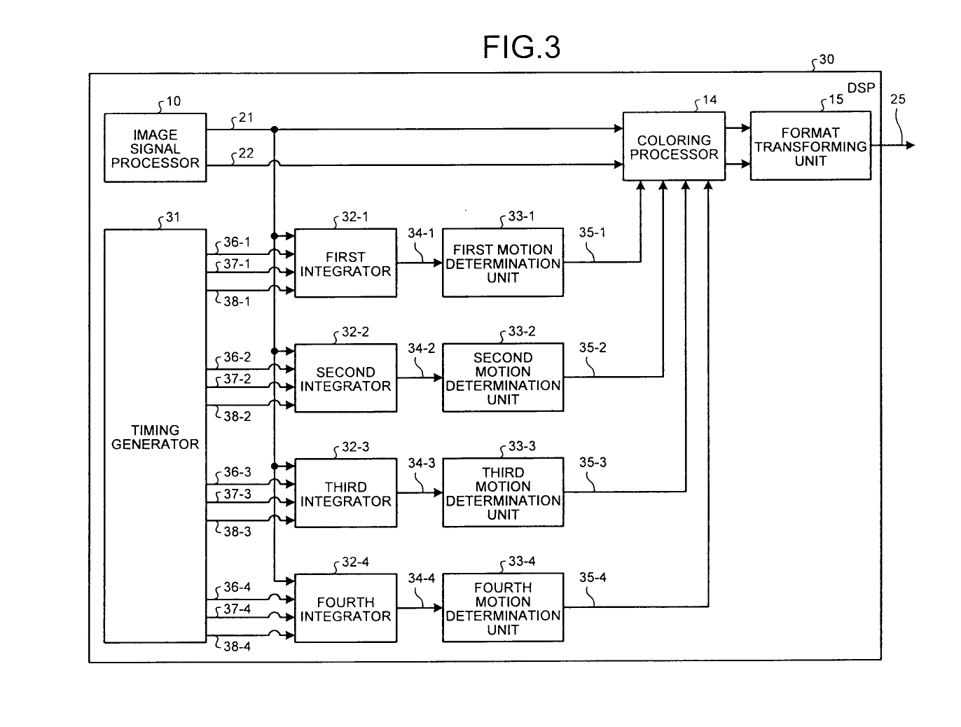

FIG. 3 is a block diagram illustrating a configuration of an image processing apparatus according to a second embodiment. A DSP 30 that is of the image processing apparatus of the second embodiment is applied to the motion detection system. The same component as the first embodiment is designated by the same numeral, and the overlapping description is omitted as appropriate.

The DSP 30 includes the image signal processor 10, a Liming generator 31, first to fourth integrators 32-1, 32-2, 32-3, and 32-4, first to fourth motion determination units 33-1, 33-2, 33-3, and 33-4, the coloring processor 14, and the format transforming unit 15.

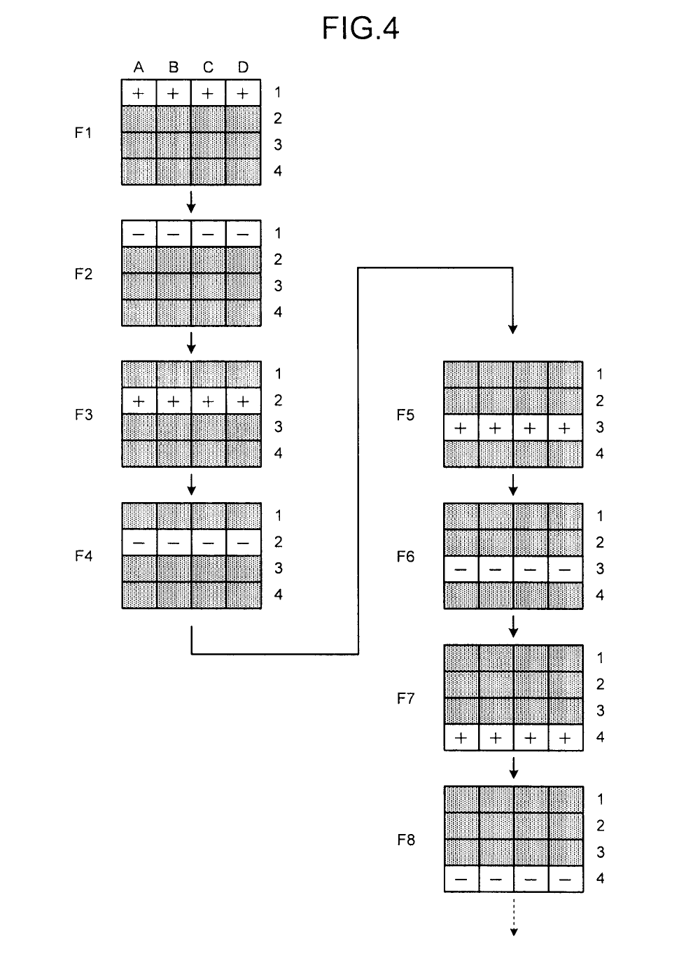

FIG. 4 is a view illustrating the integration of the luminance signal by each integrator. By way of example, the integration of the luminance signal 21 and the motion determination are performed to continuous eight frames F1 to F8.

In the second embodiment, plural unit domains are set to the image. It is assumed that a horizontal 4 (A, B, C, D) by vertical 4 (1, 2, 3, 4) matrix of domains is defined in the whole range of the image. It is assumed that each of 16 domains A1, B1, C1, D1, A2, B2, C2, D2, A3, B3, C3, D3, A4, B4, C4, and D4 constituting the 4 by 4 matrix is the unit domain. The DSP 30 simultaneously makes the motion determination in the four horizontal unit domains.

The first integrator 32-1 and the first motion determination unit 33-1 correspond to the unit domains A1, A2, A3, and A4. The second integrator 32-2 and the second motion determination unit 33-2 correspond to the unit domains B1, B2, B3, and B4. The third integrator 32-3 and the third motion determination unit 33-3 correspond to the unit domains C1, C2, C3, and C4. The fourth integrator 32-4 and the fourth motion determination unit 33-4 correspond to the unit domains D1, D2, D3, and D4.

In the frames F1 and F2, the DSP 30 performs the integration of the luminance signal 21 and the motion determination with respect to the unit domains A1, B1, C1, and D1. The timing generator 31 outputs the sensor timing signal 26 to the image sensor 3 with respect to the frame F1. When the generation of the luminance signal 21 is started with respect to the unit domain A1 of the frame F1, the timing generator 31 outputs an integration timing signal 36-1 to instruct the first integrator 32-1 to start the integration of the luminance signal 21. In response to the integration timing signal 36-1, the first integrator 32-1 integrates the luminance signal 21 with respect to the unit domain A1 of the frame F1.

The timing generator 31 outputs an integration timing signal 36-2 to instruct the second integrator 32-2 to integrate the luminance signal 21 at a time the luminance signal 21 is generated with respect to the unit domain B1 of the frame F1. In response to the integration timing signal 36-2, the second integrator 32-2 integrates the luminance signal 21 with respect to the unit domain B1 of the frame F1.

The timing generator 31 outputs an integration timing signal 36-3 to instruct the third integrator 32-3 to integrate the luminance signal 21 at a time the luminance signal 21 is generated with respect to the unit domain C1 of the frame F1. In response to the integration timing signal 36-3, the third integrator 32-3 integrates the luminance signal 21 with respect to the unit domain C1 of the frame F1.

The timing generator 31 outputs an integration timing signal 36-4 to instruct the fourth integrator 32-4 to integrate the luminance signal 21 at a time the luminance signal 21 is generated with respect to the unit domain D1 of the frame F1. In response to the integration timing signal 36-4, the fourth integrator 32-4 integrates the luminance signal 21 with respect to the unit domain D1 of the frame F1.

When the integration of the luminance signal 21 is completed with respect to the frame F1, each of the first to forth integrators 32-1, 32-2, 32-3, and 32-4 retains the integration result with respect to the frame F1 while the integration is stopped.

The timing generator 31 outputs sign switching timing signals 38-1, 38-2, 38-3, and 38-4 until the generation of the luminance signal 21 is started with respect to the unit domains A1, B1, C1, and D1 of the frame F2 since the generation of the luminance signal 21 is completed with respect to the unit domains A1, B1, C1, and D1 of the frame F1.

For example, when the luminance signal 21 is positively integrated with respect to the frame F1, the first to fourth integrators 32-1, 32-2, 32-3, and 32-4 invert the sign of the signal level of the luminance signal 21 from the positive sign to the negative sign in response to the sign switching timing signals 38-1, 38-2, 38-3, and 38-4. The first to fourth integrators 32-1, 32-2, 32-3, and 32-4 negatively integrate the luminance signal 21 with respect to the frame F2 after positively integrating the luminance signal 21 with respect to the frame F1.

The timing generator 31 outputs the integration timing signal 36-1 to instruct the first integrator 32-1 to integrate the luminance signal 21 at a time the luminance signal 21 is generated with respect to the unit domain A1 of the frame F2. In response to the integration timing signal 36-1, the first integrator 32-1 integrates the luminance signal 21 with respect to the unit domain A1 of the frame F2.

The timing generator 31 outputs the integration timing signal 36-2 to instruct the second integrator 32-2 to integrate the luminance signal 21 at a time the luminance signal 21 is generated with respect to the unit domain D1 of the frame F2. In response to the integration timing signal 36-2, the second integrator 32-2 integrates the luminance signal 21 with respect to the unit domain B1 of the frame F2.

The timing generator 31 outputs the integration timing signal 36-3 to instruct the third integrator 32-3 to integrate the luminance signal 21 at a time the luminance signal 21 is generated with respect to the unit domain C1 of the frame F2. In response to the integration timing signal 36-3, the third integrator 32-3 integrates the luminance signal 21 with respect to the unit domain C1 of the frame F2.

The timing generator 31 outputs the integration timing signal 36-4 to instruct the fourth integrator 32-4 to integrate the luminance signal 21 at a time the luminance signal 21 is generated with respect to the unit domain D1 of the frame F2. In response to the integration timing signal 36-4, the fourth integrator 32-4 integrates the luminance signal 21 with respect to the unit domain D1 of the frame F2.

When the integration of the luminance signal 21 is completed with respect to the unit domain A1 of the frame F2, the timing generator 31 outputs an integration value read timing signal 37-1. In response to the integration value read timing signal 37-1, the first integrator 32-1 outputs an integration value 34-1 with respect to the frame F1 (first frame) and the frame F2 (second frame). When outputting the integration value 34-1, the first integrator 32-1 resets the previous integration result.

When the integration of the luminance signal 21 is completed with respect to the unit domain B1 of the frame F2, the timing generator 31 outputs an integration value read timing signal 37-2. The second integrator 32-2 outputs the integration value 34-2 in response to the integration value read timing signal 37-2. When outputting the integration value 34-2, the second integrator 32-2 resets the previous integration result.

When the integration of the luminance signal 21 is completed with respect to the unit domain C1 of the frame F2, the timing generator 31 outputs an integration value read timing signal 37-3. The third integrator 32-3 outputs the integration value 34-3 in response to the integration value read timing signal 37-3. When outputting the integration value 34-3, the third integrator 32-3 resets the previous integration result.

When the integration of the luminance signal 21 is completed with respect to the unit domain D1 of the frame F2, the timing generator 31 outputs an integration value read timing signal 37-4. The fourth integrator 32-4 outputs the integration value 34-4 in response to the integration value read timing signal 37-4. When outputting the integration value 34-4, the fourth integrator 32-4 resets the previous integration result.

The first motion determination unit 33-1 makes the motion determination in the unit domain A1 according to the integration value 34-1 from the first integrator 32-1. The first motion determination unit 33-1 outputs the result of the motion determination as a determination result signal 35-1.

The second motion determination unit 33-2 makes the motion determination in the unit domain B1 according to the integration value 34-2 from the second integrator 32-2. The second motion determination unit 33-2 outputs the result of the motion determination as a determination result signal 35-2.

The third motion determination unit 33-3 makes the motion determination in the unit domain C1 according to the integration value 34-3 from the third integrator 32-3. The third motion determination unit 33-3 outputs the result of the motion determination as a determination result signal 35-3.

The fourth motion determination unit 33-4 makes the motion determination in the unit domain D1 according to the integration value 34-4 from the fourth integrator 32-4. The fourth motion determination unit 33-4 outputs the result of the motion determination as a determination result signal 35-4. Thus, the DSP 30 individually monitors the movement of the object with respect to the unit domains A1, B1, C1, and D1.

The coloring processor 14 processes the luminance signal 21 and the color-difference signal 22 in response to the determination result signals 35-1, 35-2, 35-3, and 35-4 indicating that the object moves. For example, the coloring processor 14 processes the luminance signal 21 and the color-difference signal 22 such that the domain where the object moves in the unit domains A1, B1, C1, and D1 is displayed in a predetermined color.

In the frames F3 and F4, the DSP 30 performs the integration of the luminance signal 21 and the motion determination with respect to the unit domains A2, B2, C2, and D2. In the frames F5 and F6, the DSP 30 performs the integration of the luminance signal 21 and the motion determination with respect to the unit domains A3, B3, C3, and P3. In the frames F7 and F8, the DSP 30 performs the integration of the luminance signal 21 and the motion determination with respect to the unit domains A4, B4, C4, and D4.

In the DSP 30, the first integrator 32-1 and the first motion determination unit 33-1 are used in a time-shared manner with respect to the unit domains A1, A2, A3, and A4. In the DSP 30, the second integrator 32-2 and the second motion determination unit 33-2 are used in the time-shared manner with respect to the unit domains B1, B2, B3, and B4. In the DSP 30, the third integrator 32-3 and the third motion determination unit 33-3 are used in the time-shared manner with respect to the unit domains C1, C2, C3, and C4. In the DSP 30, the fourth integrator 32-4 and the fourth motion determination unit 33-4 are used in the time-shared manner with respect to the unit domains D1, D2, D3, and D4.

Therefore, the DSP 30 determines the movement of the object in the whole range of the image from the eight frames F1 to F8. The DSP 30 repeats the same operation with respect to each unit domain in the frames subsequent to the frame F8.

In the DSP 30, the movement of the object can be determined from the eight frames with respect to the whole range of the image by the time-shared use of the first to fourth integrators 32-1, 32-2, 32-3, and 32-4. In the DSP 30, the circuit or the memory capacity for the integration can be reduced compared with the comparison of the integration values obtained in each frame. Therefore, the motion detection system can detect the movement of the object in each unit domain with the DSP 30 having the simple configuration in which the circuit scale is reduced, and illustrate the detected object as the image.

The DSP 30 is not limited to the case that the 16 unit domains are set in the image. Any number of unit domains may be set except one. The DSP 30 is not limited to the case that the motion detection is equally performed to each unit domain, but the frequency of the motion detection may vary in each unit domain.

For example, in the case of the system that monitors a person who invades into a room, the frequency of the motion detection may be increased in a domain near an entrance compared with other domains. The DSP 30 is not limited to the case that a sequence of the motion detection in each unit domain is kept constant, but the sequence may properly be changed.

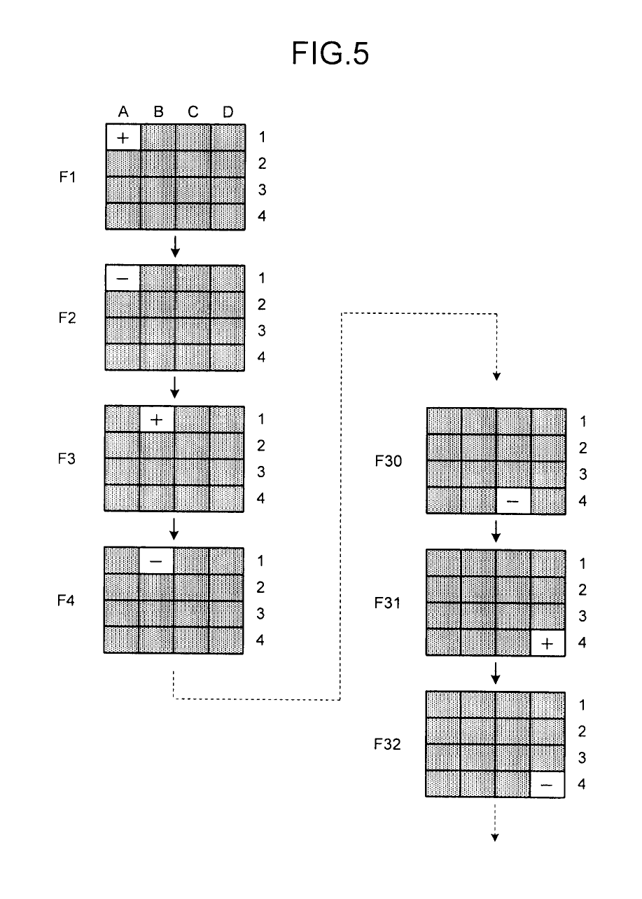

FIG. 5 is a view illustrating an operation of an image processing apparatus according to a third embodiment. The image processing apparatus of the third embodiment has the same configuration as the DSP 4 (see FIG. 1) of the first embodiment. FIG. 1 is referred to with respect to the configuration of the third embodiment, and the overlapping description is omitted as appropriate.

By way of example, the integration of the luminance signal 21 and the motion determination are performed to continuous 32 frames F1 to F32. In the third embodiment, similarly to the second embodiment, plural unit domains are set to the image. It is assumed that each of 16 domains A1, B1, C1, D1, A2, B2, 02, D2, A3, B3, C3, D3, A4, B4, C4, and D4 constituting the 4 by 4 matrix is the unit domain.

The integrator 12 integrates the luminance signal 21 in the time-shared manner in each unit domain. The motion determination unit 13 makes the motion determination in the time-shared manner in each unit domain. In the frames F1 and F2, the DSP 4 performs the integration of the luminance signal 21 and the motion determination with respect to the unit domain A1.

The timing generator 11 outputs the sensor timing signal 26 for the frame F1 to the image sensor 3. When the generation of the luminance signal 21 is started with respect to the unit domain A1 of the frame F1, the timing generator 11 outputs the integration timing signal 16 to instruct the integrator 12 to start the integration of the luminance signal 21. In response to the integration timing signal 16, the integrator 12 integrates the luminance signal 21 with respect to the unit domain A1 of the frame F1.

The timing generator 11 outputs the sign switching timing signal 18 until the generation of the luminance signal 21 is started with respect to the unit domain A1 of the frame F2 since the generation of the luminance signal 21 is completed with respect to the unit domain A1 of the frame F1. For example, the integrator 12 inverts the sign of the signal level of the luminance signal 21 from the positive sign to the negative sign in response to the sign switching timing signal 18.

The timing generator 11 outputs the sensor timing signal 26 for the frame F2 to the image sensor 3. When the generation of the luminance signal 21 is started with respect to the unit domain A1 of the frame F2, the timing generator 11 outputs the integration timing signal 16 to instruct the integrator 12 to start the integration of the luminance signal 21. In response to the integration timing signal 16, the integrator 12 integrates the luminance signal 21 with respect to the unit domain A1 of the frame F2.

When the integration of the luminance signal 21 is completed with respect to the unit domain A1 of the frame F2, the timing generator 11 outputs the integration value read timing signal 17. In response to the integration value read timing signal 17, the integrator 12 outputs the integration value 23 with respect: to the frame F1 (first frame) and the frame F2 (second frame). When outputting the integration value 23, the integrator 12 resets the previous integration result.

The motion determination unit 13 makes the motion determination in the unit domain A1 according to the integration value 23. The motion determination unit 13 outputs the result of the motion determination as the determination result signal 24. The coloring processor 14 processes the luminance signal 21 and the color-difference signal 22 in response to the determination result signal 24 indicating that the object moves. For example, the coloring processor 14 processes the luminance signal 21 and the color-difference signal 22 such that the unit domain A1 is displayed in a predetermined color.

In the frames F3 to F32, similarly to the unit domain A1, the DSP 4 makes the motion determination with respect to the 15 unit domains B1 to D4 except the unit domain A1. Therefore, the DSP 4 determines the movement of the object in the whole range of the image from the 32 frames F1 to F32. The DSP 4 repeats the same operation with respect to each unit domain in the frames subsequent to the frame F32.

The coloring processor 14 performs the coloring display in each of the unit domains A1 to D4 where the object moves, and notifies the user of the domain where the movement of the object is detected. The coloring processor 14 may perform the coloring display of the whole screen in addition to the coloring display in each of the unit domains A1 to D4. In the coloring processor 14, not only the whole unit domain may be displayed in a color, but also a part of the unit domain, for example, only an edge portion may be displayed in the color.

In the DSP 4, the movement of the object can be determined from the 32 frames with respect to the whole range of the image by the time-shared use of the integrator 12 and the motion determination unit 13. Therefore, the motion detection system can detect the movement of the object with the DSP 4 having the simple configuration in which the circuit scale is reduced, and illustrate the detected object as the image.

The DSP 4 is not limited to the case that the 16 unit domains are set in the image. Any number of unit domains may be set except one. The DSP 4 is not limited to the case that the motion detection is equally performed to each unit domain, but the frequency of the motion detection may vary in each unit domain. The DSP 4 is not limited to the case that a sequence of the motion detection in each unit domain is kept constant, but the sequence may properly be changed.

The image processing apparatus of each embodiment is not limited to the case that the motion detection is performed to the whole range of the image, but the motion detection may be performed to at least part of the image. The image processing apparatus is not limited to the case that the motion detection is performed by the integration of the luminance signal 21 in the image signals. The image processing apparatus may perform the motion detection by the integration of the information except the luminance signal 21 in the image signals, for example, the color-difference signal 22, each of RGB color signals, and a contour signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an integrator that integrates information in each pixel obtained from an image signal; and
a motion determination unit that detects a time-series change of a captured image from an integration result of the integrator, and determines movement of an object in the image,
wherein the integrator integrates the information on a first frame in a unit domain that is of a unit of motion determination made by the motion determination unit in the image of each frame and then integrates the information on a second frame subsequent to the first frame while inverting a sign of a signal level in the integration of the first frame, and the motion determination unit makes the motion determination in the unit domain according to the integration results of the first frame and the second frame in the integrator.

2. The image processing apparatus according to claim 1, wherein the motion determination unit makes the motion determination with a whole range of the image as the unit domain.

3. The image processing apparatus according to claim 1, wherein the plurality of unit domains are set in the image, and the image processing apparatus comprises: the plurality of integrators each of which integrates the information in each of the unit domains; and the plurality of motion determination units each of which makes the motion determination in each of the unit domains.

4. The image processing apparatus according to claim 1, wherein the motion determination unit makes the motion determination in each of the plurality of unit domains set in the image, and the integrator integrates the information in a time-shared manner in each of the unit domains.

5. The image processing apparatus according to claim 1, further comprising a timing generator that outputs a timing signal instructing the integrator to start the integration.

6. The image processing apparatus according to claim 1, further comprising a timing generator that outputs a timing signal instructing the integrator to switch the sign.

7. The image processing apparatus according to claim 1, further comprising a timing generator that outputs a timing signal instructing the integrator to output the integration result.

8. The image processing apparatus according to claim 1, wherein the motion determination unit previously retains a determination threshold that becomes a reference to determine whether a change of the image exists, and makes the motion determination by a comparison of the integration result and the determination threshold.

9. The image processing apparatus according to claim 1, further comprising a coloring processor that performs screen coloring display processing in response to a determination result signal indicating that the object moves from the motion determination unit.

10. The image processing apparatus according to claim 9, wherein the coloring processor continues the coloring display for a given time since the determination result signal indicating that the object moves is input.

11. An image processing method comprising:
integrating information in each pixel obtained from an image signal;
detecting a time-series change of a captured image from an integration result; and
determining movement of an object in the image,
wherein the information on a first frame is integrated in a unit domain that is of a unit of motion determination in the image of each frame and then the information on a second frame subsequent to the first frame is integrated while a sign of a signal level in the integration of the first frame is inverted, and the motion determination is made in the unit domain according to the integration results of the first frame and the second frame.

12. The image processing method according to claim 11, wherein the motion determination is made with a whole range of the image as the unit domain.

13. The image processing method according to claim 11, wherein the plurality of unit domains are set in the image, and the integration of the information and the motion determination are performed in each of the unit domains.

14. The image processing method according to claim 13, wherein the information is integrated in a time-shared manner in each of the unit domains.

15. The image processing method according to claim 11, further comprising generating a timing signal instructing to start the integration of the information.

16. The image processing method according to claim 11, further comprising generating a timing signal instructing to switch the sign.

17. The image processing method according to claim 11, further comprising generating a timing signal instructing to output the integration result.

18. The image processing method according to claim 11, further comprising performing screen coloring display processing in response to a determination result indicating that the object moves by the motion determination.

19. A motion detection system comprising:
an integrator that integrates information in each pixel obtained from an image signal; and
a motion determination unit that detects a time-series change of a captured image from an integration result of the integrator, and determines movement of an object in the image,
wherein the integrator integrates the information on a first frame in a unit domain that is of a unit of motion determination made by the motion determination unit in the image of each frame and then integrates the information on a second frame subsequent to the first frame while inverting a sign of a signal level in the integration of the first frame, and
the motion determination unit makes the motion determination in the unit domain according to the integration results of the first frame and the second frame in the integrator.
